(19) United States
(12) Patent Application Publication
(10) Pub. No.: US 2023/0366387 A1
(43) Pub. Date: Nov. 16, 2023

(54) Device for Decoupling and for Vibration Control

(71) Applicant: ABORRA AG, Opfikon (CH)

(72) Inventors: Civelek Resat, Rüschlikon (CH); Adel Amor, Emmenbrücke (CH)

(73) Assignee: ABORRA AG, Opfikon (CH)

(21) Appl. No.: 18/029,904

(22) PCT Filed: Sep. 23, 2021
(86) PCT No.: PCT/EP2021/076271

§ 371 Date: Apr. 1, 2023

(30) Foreign Application Priority Data
Sep. 23, 2020 (CH) CH01204/20

(51) Int. Cl. F04B 39/00; F04B 39/12; F16L 43/00; F16L 27/11; F16L 51/02; F16L 51/03; F16L 55/04

(52) U.S. Cl. CPC F04B 39/0055; F04B 39/123; F16L 43/008; F16L 27/11; F16L 51/024; F16L 51/025; F16L 51/035; F16L 55/041

(57) ABSTRACT

This disclosure relates to a device in the form of a connecting pipe for use in heat pump devices for decoupling as well as for vibration control. The device includes a pipe section as well as a connecting element arranged at each end. The device further includes two non-metallic, spaced, staggered bellows assemblies for vibration compensation, the pipe section having a constant material thickness between the connecting elements, apart from any individual stabilizing rings. In addition, the bellows arrangements includes of one or more annularly closed foldings, each extending 360°.

### CROSS REFERENCE TO RELATED APPLICATIONS

This application is a national phase of international application PCT/EP2021/076271, filed 23 Sep. 2021, which claims the benefit of priority to Italian patent application CH01204/20, filed Sep. 23, 2020, which the content of each of the aforementioned patent applications being incorporated herein by reference.

### BACKGROUND OF THE INVENTION

### Field of the Invention

The present invention describes a device in the form of a connecting pipe for use in heat pump devices, comprising a pipe section and a connecting element arranged at each end, for decoupling and for vibration control, in particular for vibration decoupling, in a vibration generator such as a compressor or a pump. In particular, the device according to the invention serves to compensate for movements and assembly inaccuracies in connection with such systems or vibration generators.

### Description of Related Art

Various heat pump devices are known from the prior art, whereby these usually comprise at least a compressor, a condenser (i.e. liquifier), an expansion device (in particular an expansion valve) and an evaporator.

The heat pump is technically constructed like a refrigerator with the difference that in the heat pump the warm side (i.e. the condenser of the heat pump) is used for heating. In other words, both the heat pump device and the refrigerator are based on an HVAC compressor system (i.e. heating, ventilation, air conditioning or refrigeration).

A basic problem with known heat pump devices is noise generation. The compressor generates vibrations during operation, which can include both vibrations of the compressor itself, which can be transmitted to other parts of the system through mechanical interconnections, and vibrations in the compressed working fluid that exits the compressor outlet.

One or more vibration control devices may be located along the refrigerant circuit to control one or both of these vibration sources.

In principle, vibration control devices are known to control such vibration sources, for example, by placing the vibration control device between the compressor and the condenser (i.e. liquifier).

Sound insulation of the compressor of the heat pump device is of particular importance in this respect, so that the installation of the compact heat pump is possible without loss of comfort within the living space to be heated.

Furthermore, a heat pump device is known from the document DE 10 2008 016 577 A1, comprising a compact heat pump the size of an electric storage heater, the compact heat pump having a housing in which at least one compressor and one condenser (i.e. liquifier) are arranged.

The housing of the heat pump device disclosed here has a sound-insulated section in which a compressor is arranged, whereby a device for controlling pulsation and vibration is achieved.

In particular, the walls of this soundproofed section are covered with a suitable soundproofing material, e.g. soundproofing mats several cm thick. The fastening elements for floor and wall fastening or the feet for free mounting are also provided with sound-insulating elements, e.g. rubber washers, in order to prevent the transmission of vibrations as far as possible. The walls provide a sound-insulating separation between the compressor and the condenser.

The device for pulsation and vibration control known from the document DE 10 2008 016 577 A1 has the disadvantage that pulsation and vibration control is achieved here with very costly means.

The further document DE 20 2018 102 825 U1 discloses a further device for pulsation and vibration control for a compressor in an HVAC compressor system (i.e. heating, ventilation, air conditioning or refrigeration technology) or in a heat pump arrangement. In particular, the device for pulsation and vibration control is also arranged between a compressor and a discharge line, e.g. to the condenser (liquifier).

The device for pulsation and vibration control known from the document DE 20 2018 102 825 U1 comprises a silencer unit with a flange at one compressor end, a silencer body, one or more vibration damping structures, such as baffles inside the muffler body and a free end of the muffler opposite the compressor end, a bellows assembly attached to the flange and extending the length of the muffler body to a baffle, and wherein the free end of the muffler and the baffle do not contact each other.

The foldings of the bellows assembly are described in document DE 20 2018 102 825 U1 as consisting of several layers of metal such as copper or steel.

In other words, this is a design that integrates silencers and bellows to achieve noise reduction, i.e. sound and vibration reduction, within an HVAC compressor system (i.e. heating, ventilation, air conditioning or refrigeration) or heat pump arrangement, respectively.

The device for pulsation and vibration control known from the document DE 20 2018 102 825 U1 has the disadvantage that the device has a comparatively complicated structure with structural supports, silencer flanges, welds, etc. The device is designed to control the pulsation and vibration of the compressor.

Another known state of the art is a “flexible flanged rubber expansion joint” from Nortech, which functions as a vibration control device and has an elastic pipe section between two connecting flanges. In this case, the elastic pipe section has a spherical protrusion in the center.

This device for vibration control from Nortech has the disadvantage that it is difficult to handle during assembly.

Furthermore, insulated heat pump connecting hoses are known from the prior art, which fluidically connect the individual components, in particular the compressor, the condenser (i.e. liquifier), the expansion device (in particular an expansion valve) and the evaporator.

EP 3070387 A1 also describes a flexible coupling used in the aircraft industry in the field of ventilation technology. This has a thin thickness of material in two straight areas, between which a bend is arranged, and two serrated foldings in the center thereof to increase flexibility during assembly.

### BRIEF SUMMARY OF THE INVENTION

The present invention has set itself the task of creating a device described at the outset for pulsation and vibration control with respect to a vibration generator for a heat pump installation, the device being characterized by a simple design and simplified handling with simultaneously effective pulsation and vibration control. The aim is to keep noise transmission from the vibration generator as low as possible.

According to the invention, the device for vibration compensation described at the outset comprises precisely two non-metallic, spaced-apart, offset bellows assemblies for vibration compensation, the pipe section between the connecting elements having a constant material thickness, apart from any individual stabilizing rings or reinforcing ribs, and the bellows assemblies consisting of one or more annularly closed folds each running through 360°. Spiral-shaped folds, in contrast to annularly closed folds, can absorb considerably less energy because valuable space is taken up for the beginning and end of the fold, which has a stiffening effect rather than an elastic effect. Similarly, foldings that are designed to be less than 360° circumferential are only partially elastic and therefore unsuitable for the present invention.

In particular, the folds should be as close as possible to the connecting elements so that the pipe section between the two bellows assemblies is as long as possible. The distance from the end of the device to the bellows assembly should be less than two folds. This distance also includes the area where the connecting elements are arranged. If the connecting elements require little space, this distance can also be shorter than 1.5 or shorter than one folding. The direct proximity of the foldings 16 to the connection elements also has the particular advantage of requiring little space, since the installation conditions for heat pumps are very tight.

In addition, the elevations of the foldings should be as short as possible. This means that they should follow an approximately sinusoidal line in their centerline, in longitudinal section, or that the centerline within the material should simulate approximately spherical segments with the same radii. The radii should be of the same order of magnitude as the thickness of the material, preferably with a deviation of no more than a factor of 1.5. This ensures that the wall of the tube in the bellows assemblies can absorb a great deal of vibration energy, since the entire bellows areas are soft and these cannot themselves form resonances.

The thicker and softer the material, the higher the dissipation, i.e. the absorption of vibration energy and conversion into heat energy. Stiff, hinged segments within the bellows areas, as described in EP 3070378 A1, not only do not contribute to dissipation, they can even be the cause of resonance formation.

Preferably, the pipe section is made in one piece. Since the compressive stress in the application of a heat pump is very high, then the pipe section can be reinforced with a carcass. Preferably, the pipe section consists largely of an elastomer in terms of volume.

In other words, the device according to the invention has a rubber compensator in the form of a non-metallic bellows arrangement.

For the purposes of the present invention, a bellows assembly is understood to be a hose which folds up in an accordion-like manner.

The advantage of the device for decoupling and vibration control according to the invention is that, due to its simple design essentially in the form of a bent tube with two connecting flanges at the ends, it is particularly easy to assemble and disassemble, i.e. the device can be easily decoupled from the other components of the HVAC compressor system (i.e. heating, ventilation, air-conditioning or refrigeration technology) or the heat pump arrangement.

In particular, by choosing a bellows assembly with foldings made of a non-metallic material, it has been found advantageously that the design can be significantly simplified compared to that of document DE 20 2018 102 825 U1 with foldings made of a metallic material.

Compared to document DE 10 2008 016 577 A1, according to the invention a device is realized which combines a sound insulation and a fluidic connection in a simple way.

Compared to the “flexible flanged rubber expansion joint” of the company Nortech with a centrally arranged, spherical bulge with only minimal angular deflection possibility, the device according to the invention advantageously allows significantly larger angular deflections and the device according to the invention enables the necessary lateral movements for vibration decoupling.

In principle, it is conceivable that the device according to the invention is alternatively used in the application areas of power engineering, industrial water treatment or plant construction, in which, in addition to compressors, further vibration generators such as pumps, in particular water pumps (for example a pump in the feed area of reverse osmosis systems), are used.

Preferably, the device according to the invention for decoupling as well as for vibration control is arranged between the compressor and the condenser (i.e. liquifier).

Preferably, the pipe section is bent, whereby two legs are spanned with an angle of between 75° and 120°, even more preferably an angle of about 90°, and thus two legs are formed at an angle to each other, to which the bellows assembly is arranged.

Preferably, the bellows assembly of the device according to the invention is arranged in direct contact with a connecting element. A bellows assembly of this type has the advantage that the largest possible lever arm is formed between the bellows regions and handling is thus substantially simplified. In other words, the large lever arm between the bellows allows particularly generous freedom of assembly and especially advantageous vibration decoupling.

Preferably, a pipe section of the device according to the invention for decoupling and for vibration control is formed in one piece and thus the bellows assembly is integrated in one piece into the pipe section of the device. This one-piece design has the particular advantage that the risk of leakage is practically eliminated and that the risk of possible assembly errors is particularly reduced.

A further aspect of the present invention relates to a use of the device 2 according to the invention as a fluidic connection and for decoupling and vibration control with respect to a vibration generator, for example with respect to a pump or with respect to a compressor in a heat pump device.

### BRIEF DESCRIPTION OF THE SEVERAL VIEWS OF THE DRAWINGS

Further advantages, features, and details of the various embodiments of this disclosure will become apparent from the ensuring description of a preferred exemplary embodiment and with the aid of the drawings. The features and combinations of features recited below in the description, as well as the features and feature combination shown after that in the drawing description or in the drawings alone, may be used not only in the particular combination received, but also in other combinations on their own, without departing from the scope of the disclosure.

A preferred embodiment of the subject matter of the invention is described below in connection with the accompanying drawings, wherein:

FIG. 1 shows a first preferred embodiment of the device according to the invention for decoupling as well as for vibration control with a connecting element in the form of a connecting flange;

FIG. 2 shows a second preferred embodiment of the device for decoupling and vibration control according to the invention with a connecting element in the form of a screw connection;

FIG. 3A shows a longitudinal section through the first preferred embodiment with a connecting element in the form of a connecting flange and with a plurality of stabilizing rings;

FIG. 3B shows a detailed view of an area B of the first preferred embodiment of the device according to the invention of the connecting element designed as a connecting flange;

FIG. 3C shows a front view of the first preferred embodiment of the device according to the invention with a connecting element in the form of a connecting flange;

FIG. 4A shows a longitudinal section through the first preferred embodiment of the device according to the invention for decoupling and vibration control with a connecting element in the form of a connecting flange;

FIG. 4B shows a detailed view of the connecting element in the form of a screw connection of the second preferred embodiment of the device for decoupling and vibration control according to the invention;

FIG. 4C shows a detailed view of the connecting element in the form of a press system of a third preferred embodiment of the device according to the invention;

FIG. 5A shows a fourth preferred embodiment of the device according to the invention for decoupling and vibration control with a connecting element in the form of a groove connection;

FIG. 5B shows a section C-C through the fourth preferred embodiment of the device according to the invention with a connection element in the form of a groove connection.

FIG. 6A shows a fifth preferred embodiment of the device according to the invention for decoupling and for vibration control with a connecting element in the form of a further screw connection;

FIG. 6B shows a section D-D through the further screw connection of the fifth preferred embodiment of the device according to the invention; and

FIG. 7 shows an HVAC compressor system.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that at least one of “A, B, and C” should not be understood as including only one of A, only one of B, only one of C, or any combination of A, B, and C.

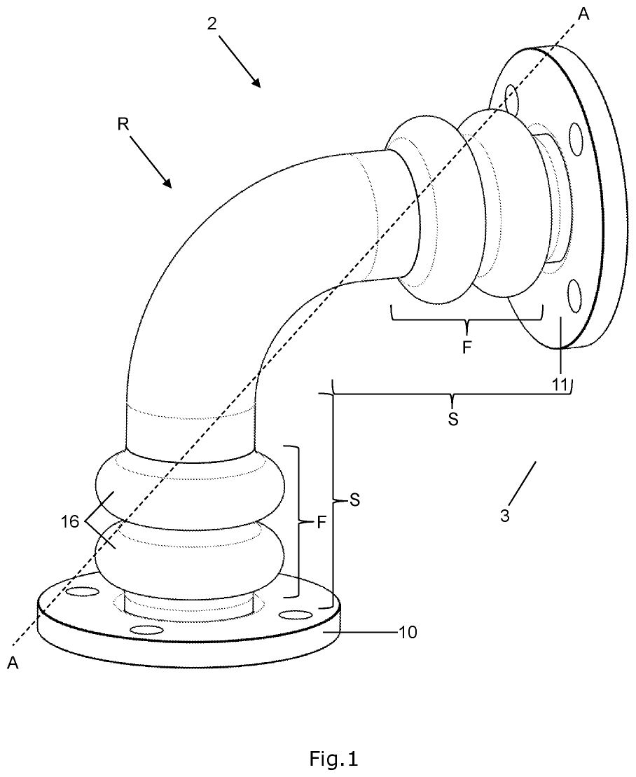

FIG. 1 shows a first preferred embodiment of the device 2 according to the invention for decoupling as well as for vibration control with a first and second connecting flange 10; 11 attached at the end in each case as connecting element.

This first preferred embodiment of the device 2 for decoupling and vibration control according to the invention comprises here a pipe section R, which is bent and thereby spans two legs S. The device 2 comprises at least two connecting flanges 10; 11 as connecting elements.

The device 2 here comprises at least two spaced, offset bellows assemblies F for vibration compensation.

The device 2 comprises a non-metallic bellows arrangement F in a region towards each of the end connection elements. A bellows assembly F here has, by way of example, two foldings 16 in each case, although one folding 16 or three foldings 16 are also possible in each case. Particularly preferably, the two foldings 16 of the bellows assembly F are made of a rubber material or elastomer, in particular ethylene-propylene-diene rubber (EPDM), nitrile rubber (NBR), butyl rubber, silicone or any combination thereof. Very preferably, the inner surface of the pipe section R of the device 2 may be provided with a water-repellent coating, for example a Teflon coating.

From here on and in the following, identical reference signs denote identical components in the figures.

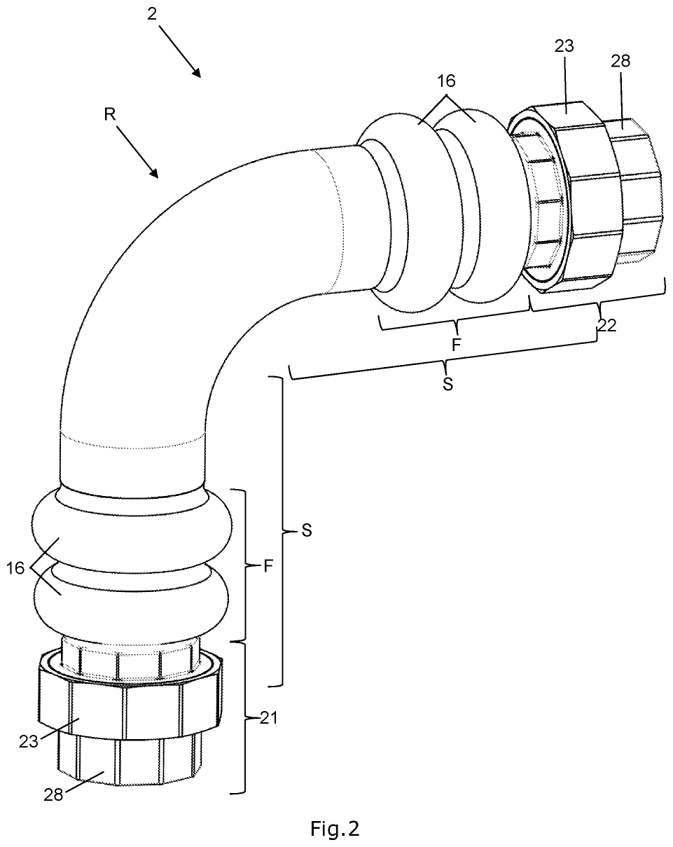

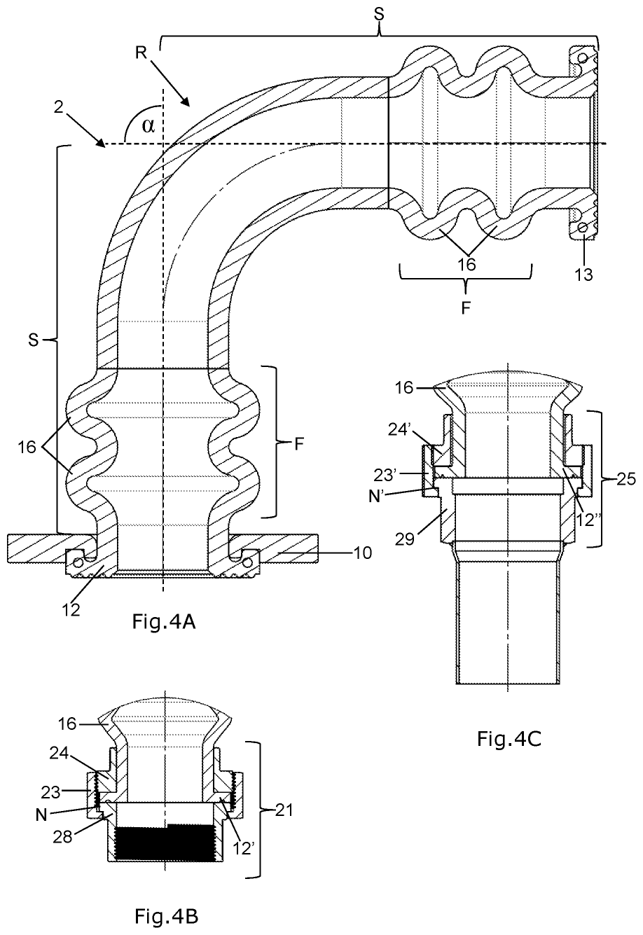

FIG. 2 shows a second preferred embodiment of the device 2 according to the invention for decoupling as well as for vibration control with a connecting element in the form of a screw connection 21; 22, here in each case in three parts, as explained again in detail in FIG. 4B. The screwed connections 21; 22 of the union nuts 23 and the connecting nut 28; 28′ are designed here as a polygon nut.

The screw connection 21; 22 can be made of metal. According to a preferred further development of the present invention, it is also conceivable that the screw connection is made of a non-metallic material, i.e. in particular of a plastic such as (PE) or PVC, plastic being advantageous for applications in the food and chemical sector.

Preferably, the device 2, i.e. in particular the pipe section R, can be made of a vulcanized unit elastomer such as ethylene-propylene-diene rubber (EPDM), butyl rubber, nitrile rubber (NBR), silicone. The choice of such an elastomer has the advantage of low diffusion or low gas permeability.

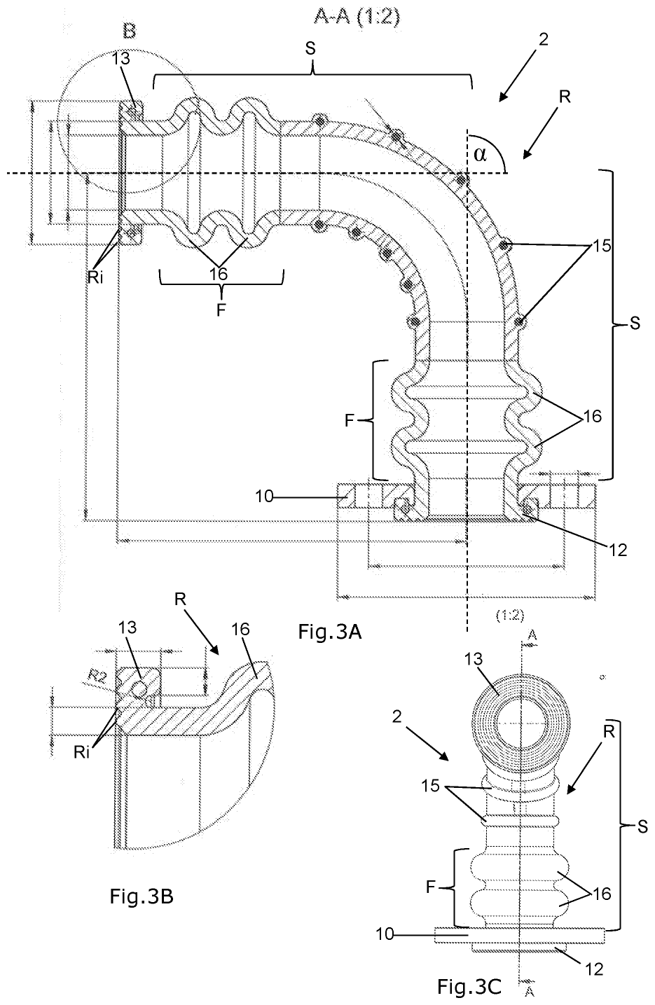

FIG. 3A shows a longitudinal section through the first preferred embodiment with a connecting element in the form of a connecting flange 10 and with a plurality of stabilizing rings 15.

As can be seen in FIG. 3A, the pipe section R of the device 2 according to the invention for decoupling and for vibration control is formed in one piece, whereby the bellows arrangement F is integrated in one piece in the pipe section R of the device 2.

Furthermore, it can be seen in FIG. 3A that the pipe section R of the device 2 integrally forms a first and a second sealing ring 12; 13, respectively, at each end, the sealing rings 12; 13 preferably being provided with a corrugation Ri.

As can be seen in FIG. 3A, the pipe section R is bent and two legs S are clamped with an angle α of between 75° and 120°, more preferably an angle of about 90°, and thus two legs S are formed which are at an angle to one another and on which the bellows assembly F is arranged. Particularly preferably, an angle α formed between the two legs S is essentially at right angles.

It has been shown advantageously that the attachment of additional stabilizing rings 15 in an area between the bellows assemblies F is particularly suitable for applications of higher pressure levels. As shown in FIG. 3A, five stabilizing rings 15 are arranged here as an example. In addition or alternatively, the pipe section R can also be reinforced with a carcass.

The decisive factor is that the material thickness in the pipe section R between the connecting elements is constant, except where necessary in the area of the stabilizing rings 15 or reinforcing ribs, where bulges can occur. Areas of lower material thickness would inevitably lead to breakthroughs, since the pressures in the above-mentioned application area are very high. The best dimensional and compressive stability with minimum material usage can be achieved with a uniform material thickness. Additional support ribs or stabilizing rings can still be fitted.

As can be seen from the figures, the bellows assemblies F consist of one or more annularly closed folds 16, each running 360° around. The individual folds 16 of the bellows assemblies F are designed in such a way that in a longitudinal section, as shown in FIG. 3a, the centerline within the material replicates approximately spherical segments with the same radii. Generally, these are approximately hemispherical segments which are lined up, with quarter spherical segments attached at the ends. The radii are constant but extending in different directions, so that approximately sinusoidal shapes of the foldings 16 are formed. There are no straight sections in between. The radii correspond approximately to the material thickness, although a deviation of a factor of 1.5 is permissible.

FIG. 3B shows a detailed view of an area B shown in FIG. 3A of the first preferred embodiment of the device 2 according to the invention of the connecting element designed as a connecting flange. The distance from the end of the device 2, where the corrugation Ri is also shown, to the bellows assembly F should be kept as small as possible. In this illustration, this distance is less than a folding. In other arrangements, where the connecting element takes up more space, this distance can be as wide as two foldings. This distance should be kept as small as possible so that the pipe section R between the bellows assemblies F is maximized. It has been shown that this can reduce sound transmission.

FIG. 3C shows a front view of the first preferred embodiment of the device according to the invention with a connecting element in the form of connecting flanges 12; 13.

FIG. 4A shows a longitudinal section A-A through the first preferred embodiment of the device 2 according to the invention for decoupling as well as for vibration control with a connecting element in the form of a connecting flange 10. Here, too, the distance from the end of the pipe section R to the first folding is smaller than the width of a folding.

As an alternative to the connecting flanges shown in FIG. 4A, FIG. 4B shows a detailed view of the connecting element in the form of a screw connection 21 of the second preferred embodiment of the device 2 according to the invention shown in FIG. 2 for decoupling as well as for vibration control. The screw connection 21 is here in three parts and comprises a ring-shaped connection support element 24, which can, for example, be fastened in a material-locking manner to the outer wall of the pipe section R, for example by bonding or welding. The connection support element 24 here shows an external thread. A union nut 23 here has an internal thread corresponding to the external thread of the connection support element 24 and surrounds a projecting nose N of a polygonal connecting nut 28 for establishing a connection between the tube section R of the device 2 according to the invention and the connecting nut 28 provided with an internal thread.

FIG. 4C shows a detailed view of the connection element in the form of a press system or a press connection 25 of a third preferred embodiment of the device 2 according to the invention.

The press system or press connection 25 comprises a connection support element 24′, a union nut 23′ provided with an internal thread, and a sealing ring 12″. At the end of the tube section R of the device 2, a sealing ring 12″ is formed in one piece at each end.

The connection support element 24′ can, for example, be fastened to the outer wall of the pipe section R by adhesive bonding or welding.

By means of the union nut 23′, a press connection is made here between the connection support element 24′ and a second pipe connection 29, in that an internal thread of the union nut 23′ interacts with an external thread of the connection support element 24′. Furthermore, the union nut 23′ encloses a nose N′ of the pipe connection 29 for establishing a fluid-tight connection between the pipe section R of the device 2 according to the invention and the pipe connection 29.

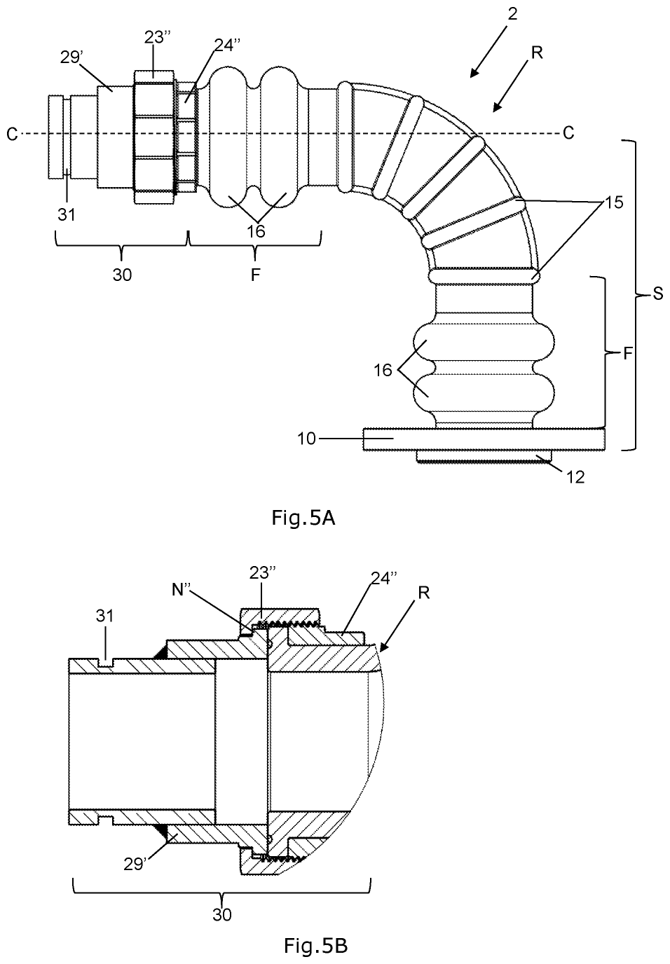

FIG. 5A shows a fourth preferred embodiment of the device 2 according to the invention for decoupling and for vibration control with a connection element in the form of a groove connection 30.

FIG. 5B shows a section C-C through the fourth preferred embodiment of the device 2 according to the invention with a connection element in the form of a groove connection, whereby a connection with a connection pipe not shown here can be made preferably with a pipe coupling.

A connection support element 24″ is here exemplarily materially fastened to the outer wall of the pipe section R, for example by gluing or welding, and is provided with an external thread. Here, a sealing ring 12″ is formed integrally with the pipe section Rat the end. In this arrangement, the distance from the end of the pipe section R to the first folding is slightly greater than the width of a fold.

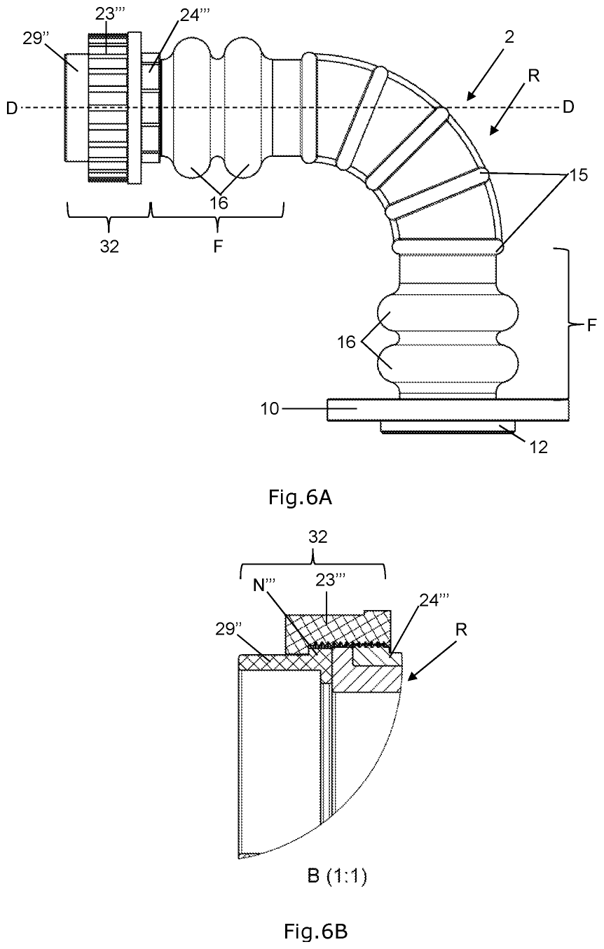

FIG. 6A shows a fifth preferred embodiment of the device according to the invention for decoupling as well as for vibration control with a connection element in the form of a third screw connection 32.

FIG. 6B shows a section D-D through the further screw connection 29 of the fifth preferred embodiment of the device 2 according to the invention. The third screw connection 32 shown here comprises a union nut 23′″ as well as a connection support element 24′″ which is connected to the pipe section R by a material bond.

The union nut 23′″ here has an internal thread corresponding to the external thread of the connection support element 24- and surrounds a projecting nose N′″ of a second pipe connection 29″ for establishing a connection between the pipe section R of the device 2 according to the invention and the second pipe connection 29″.

Preferably, the union nut 23″ and the second pipe connection 29″ of the third screw connection 32 are made of a non-metallic material, i.e. in particular of a plastic such as polyethylene (PE) or polyvinyl chloride (PVC), plastic being advantageous for applications in the food and chemical sectors.

For the purposes of the present invention, any combination of the arrangements shown in FIG. 1 to FIG. 6B at the two ends of the pipe section R is conceivable. In this arrangement, the distance from the end of the pipe section R to the first folding 16 corresponds approximately to the width of a fold.

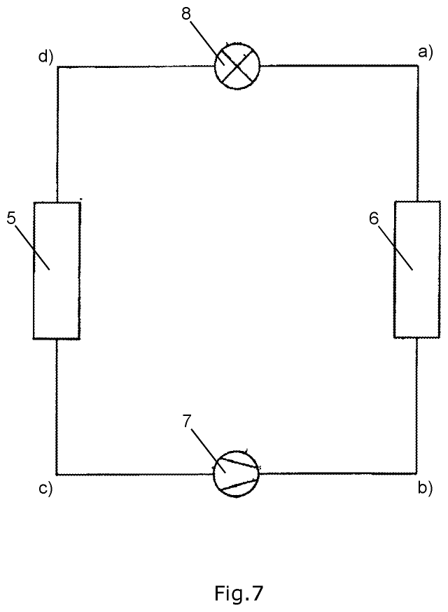

FIG. 7 shows an HVAC compressor system, on which a heat pump device is also based, which can comprise the device 2 according to the invention. The HVAC compressor system/heat pump device 1 comprises a compressor 7, a condenser 6, an expansion device, for example an expansion valve 8, and an evaporator 5. The compressor 7, the condenser 6, the expansion device and the evaporator 5 are fluidically connected in sections a) to d) for transferring a heat transfer fluid. In the case of air as the gaseous heat transfer fluid, this is typically an air conditioning system or a heat pump system. The device 2 according to the invention can preferably be arranged in a section b) between compressor 7 and condenser 6.

Since the devices and methods described in detail above are examples of embodiments, they can be modified to a wide extent by the skilled person in the usual manner without departing from the scope of the invention. In particular, the mechanical arrangements and the proportions of the individual elements with respect to each other are merely exemplary. Some preferred embodiments of the apparatus according to the invention have been disclosed above. The invention is not limited to the solutions explained above, but the innovative solutions can be applied in different ways within the limits set out by the claims.

1. A device for use in heat pumps for decoupling and vibration control, the device comprising:
a pipe section; and
a connecting element arranged at each end; and
wherein the device further comprises two non-metallic, spaced, staggered bellows assemblies configured to compensation for vibration;
wherein the pipe section comprises a constant material thickness between the connecting elements, apart from any individual stabilizing rings or reinforcing ribs, and
wherein the bellows arrangements comprises one or more annularly closed folds each running through 360°.

2. The device according to claim 1;
wherein the pipe section is bent; and
further comprising two legs arranged at an angle and upon the bellows assembly is arranged.

3. The device according to claim 1, further comprising a connecting element arranged such that
the bellows assembly is arranged in direct contact with the connecting element such that the distance from an end of the device to the bellows assembly is less than two foldings.

4. The device according to claim 1, wherein
the pipe section comprises one piece configured for decoupling and for vibration control; and
the bellows assembly is arranged integrated in one piece into the pipe.

5. The device according to claim 1, wherein
the bellows assembly comprises between one and three foldings.

6. The device according to claim 1, further comprising
a plurality of stabilizing rings fitted between the bellows assemblies.

7. The device according to claim 1, wherein
the connecting element is a flange connection, a press system, a screw connection or a groove connection.

8. The device according to claim 1, wherein the foldings, in a longitudinal section, comprise center line within forming spherical segments of a same radius.

9. The device according to claim 8, wherein the radius is of an order of magnitude of a material thickness of the pipe section.

10. The device according to claim 1, wherein the pipe section comprises an elastomer.

11. The device according to claim 1, further comprising a carcass reinforcement.

12. A system comprising
a heat pump;
a device for use in heat pumps for decoupling and vibration control, the device comprising a pipe section and a connecting element arranged at each end; wherein the device further comprises two non-metallic, spaced, staggered bellows assemblies configured to compensation for vibration; wherein the pipe section comprises a constant material thickness between the connecting elements, apart from any individual stabilizing rings or reinforcing ribs; and wherein the bellows arrangements comprises one or more annularly closed folds each running through 360°, and
wherein the device is configured for a fluidic connection and for decoupling and vibration control with respect to at least one of a vibration generator, the pump, and a compressor.

13. The device according to claim 2, wherein the angle is between 75 degrees and 120 degrees.

14. The device according to claim 2, wherein the angle is about 90 degrees.

15. The device according to claim 2, wherein
the pipe section comprises one piece configured for decoupling and for vibration control; and
the bellows assembly is arranged integrated in one piece into the pipe.

16. The device according to claim 1, wherein the bellows assembly comprises two foldings.

17. The device according to claim 1, further comprising six stabilizing rings fitted between the bellows assemblies.
